(19) United States
(12) Patent Application Publication
(10) Pub. No.: US 2012/0131485 A1
(43) Pub. Date: May 24, 2012

(54) SYSTEM AND METHOD FOR PROVIDING INTERACTIVE TAB MANAGEMENT IN TABBED BROWSERS

(75) Inventors: Christopher SVENDSEN, Oslo (NO); Knut-Jørgen V. Rishaug, Oslo (NO); Petter Nilsen, Oslo (NO)

(73) Assignee: OPERA SOFTWARE ASA, Oslo (NO)

(21) Appl. No.: 13/302,882

(22) Filed: Nov. 22, 2011

Related U.S. Application Data
(60) Provisional application No. 61/416,493, filed on Nov. 23, 2010.

(51) Int. Cl. G06F 3/048

(52) U.S. Cl. 715/769; 715/777

(57) ABSTRACT

The invention is directed to a method, computer system, and computer program for providing grouped tabs in a web browser. When multiple web pages are open in multiple tabs, a user initiated event indicating the creation of a group of tabs can be detected and at least two tabs may be associated with the created group. A group tab representing the group of tabs can then be displayed in place of all the individual tabs.

### CROSS-REFERENCE TO RELATED APPLICATION

The present application claims priority under 35 U.S.C. §119(e) to U.S. provisional patent application No. 61/416,493 filed Nov. 23, 2010, the entire contents of which are herein incorporated by references in their entirety.

### FIELD OF THE INVENTION

The present invention is directed to tabbed browsing, and in particular to interactive tab management that allows a user to organize tabs in groups.

### BACKGROUND

Traditionally, web browsers have included a single window displaying a page of content. When a user enters a URL, clicks on a link on a previously opened page, or otherwise identifies a given page, the browser application retrieves the contents of the selected page and displays it in the browser application window.

Tabbed browsing has been developed to provide users with greater flexibility, including the ability to enable multiple pages to be simultaneously opened within a single browser application window. Each open page is associated with a tab that can be selected by a user, and the contents of the selected tab will be displayed by the browser. If the user desires to retrieve a new page from a web site without losing the content contained in an already loaded page, a new tab can be opened and the new content can be loaded and associated with the new tab without disturbing the content of any previously opened tab. The user can then switch back and forth between pages simply by switching between the tabs.

Additionally, each tab maintains its own history of web pages that have been opened, which allows the user to navigate back and forth through the browsing history of a single tab without interfering with the history of any other tab.

As users have become familiar with tabbed browsing, it has become common to have a very large number of tabs open at the same time. It is not unusual for a user to have a very large number of tabs open at the same time, perhaps as many as thirty (30), forty (40) or even fifty (50) tabs at the same time. In addition, users may keep tabs alive between browsing sessions, meaning that some tabs may represent browsing that was interrupted several days earlier. This creates the problem of locating a desired tab when it is needed. The number of tabs alone means that there are many tabs to search through. In addition, limited display space means that the more tabs are open, the smaller each tab becomes. When many tabs may not have been used for several days as well, the users may not remember how he or she tried to organize the tabs in order to relocate them easily.

Consequently, there is a need for better organization and easier relocation of and access to tabs when many tabs are open.

### SUMMARY OF THE INVENTION

The present invention relates to a method, system, and computer program for providing a user with the ability to organize tabs in groups when desired. The invention also provides features related to how these groups are displayed in a browser window.

A method in a browser for providing grouping of tabs when multiple web pages are open in multiple tabs may comprise utilizing a computer processor to execute a process of detecting a user initiated event indicating the creation of a group of tabs, associating at least two tabs with the created group, and displaying a group tab representing the group of tabs.

The tab representing the group of tabs can be displayed in one of two states: one representing the group tab in a collapsed state, and the other representing the group tab in an open state. The tabs contained within the group tab are shown when the group tab is in the open state, but not when the group tab is in the collapsed state.

According to some embodiments the user initiating event comprises dragging and dropping one tab on top of another with a mouse type input device.

When a collapsed tab is displayed, a button that toggles the tab to an open state may also be displayed. Similarly, when an open tab is displayed, a button that toggles the tab to a collapsed state may also be displayed.

According to some embodiments the process further comprises maintaining a list of all open tabs at a first level; upon creating the group of tabs, creating a first list of tabs at a second level; entering an identification of a group tab associated with the group of tabs in the list of tabs at the first level; and entering an identification of the at least two tabs in the first list of tabs at a second level.

Consistent with the principles of the invention, some embodiments allow several groups of tabs to exist at the same time. The process may then further comprise the detection of a user initiated event indicating the creation of a second group of tabs, followed by the creation of a second list of tabs at said second level. An identification of a group tab associated with the second group of tabs can then be entered in the list of tabs at the first level, and an identification of at least two tabs associated with the second group of tabs can be entered in the second list of tabs at the second level.

The invention also comprises a computer system including a computer processor for executing the process described above, as well as a computer readable medium on which is stored a program that, when executed by a computer processor, causes the process described above to be executed.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein

FIG. 1 is a block diagram illustrating a computing environment that can be used for implementing exemplary embodiments of the present invention;

FIG. 2 is a block diagram illustrating a web browser for accessing data resources in accordance with an exemplary embodiment of the present invention;

FIGS. 3A-3D illustrate part of a web browser window implementing an exemplary embodiment of the invention.

FIG. 4 is a flow chart further illustrating an exemplary embodiment in connection with the example of FIG. 3.

The drawings will be described in detail in the course of the detailed description of the invention.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

The invention relates to tabbed browsing, and in particular to the way tabs are organized and displayed adjacent a browser window and how a user can reorganize and group these tabs.

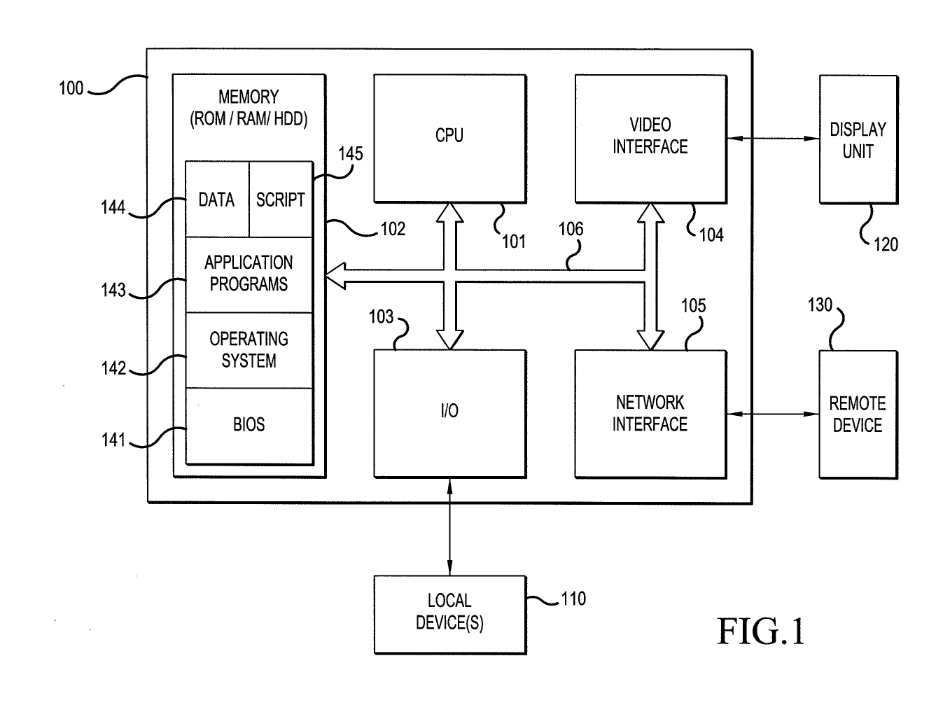

FIG. 1 illustrates a generalized computer system 100 that can be used as an environment for implementing various aspects of the present invention. According to exemplary embodiments, it is contemplated that the computer system 100 may be implemented as any of various types of general purpose computers, including but not limited to servers, desktop computers, laptop computers, distributive computing systems, and any other type of computing devices and systems as will be contemplated by those of ordinary skill in the art.

In FIG. 1, computer system 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memory, stores the various software components of the system. The software components in the memory 102 may include a basic input/output system (BIOS) 141, an operating system 142, various computer programs 143 including applications and device drivers, various types of data 144, and other executable files or instructions such as macros and scripts 145.

The communication ports 103 may be connected to one or more local devices 110. Examples of local devices 110 that can be connected to a communication port 103 include (but are not limited to) user input devices (e.g., mouse or keyboard), a printer, a media player, external memory devices, and special purpose devices (e.g., a global positioning system receiver (GPS)). Communication ports 103, which may also be referred to as input/output ports (I/O), may be any combination of such ports as USB, PS/2, RS-232, infra red (IR), Bluetooth, printer ports, or any other standardized or dedicated communication interface for the corresponding local devices 110.

The video interface device 104 is connected to a display unit 120. The display unit 120 might be an integrated display. For instance, if the computer system 100 is implemented in a portable device, such as a laptop or “netbook” computer, the display will generally be an integrated display such as an LCD display. However, the display unit 120 does not have to be integrated with the other elements of the computer system 100, and can instead be implemented as a separate device, e.g., a standalone monitor.

The network interface device 105 provides the computer system 100 with the ability to connect to a network in order to communicate with a remote device 130. The communication network, which in FIG. 1 is only illustrated as the line connecting the network interface 105 with the remote device 130, may be, e.g., a local area network or the Internet. The remote device 130 may in principle be any computing device or system with similar communications capabilities as the system 100, such as a server or some other unit providing a networked service.

It will be understood that the computer system 100 illustrated in FIG. 1 is not limited to any particular configuration or embodiment regarding its size, resources, or physical implementation of components. For example, more than one of the functional components illustrated in FIG. 1 may be combined into a single integrated unit of the system 100. Also, a single functional component of FIG. 1 may be distributed over several physical units. Other units or capabilities may of course also be present. Furthermore, while it is contemplated that the system 100 may be implemented using general purpose computers or servers, various aspects of the present invention could be implemented using a system 100 that is smaller and/or has more limited processing capabilities (e.g. a laptop or netbook computer, a personal digital assistant (PDA), or a set-top box system or other home-entertainment unit).

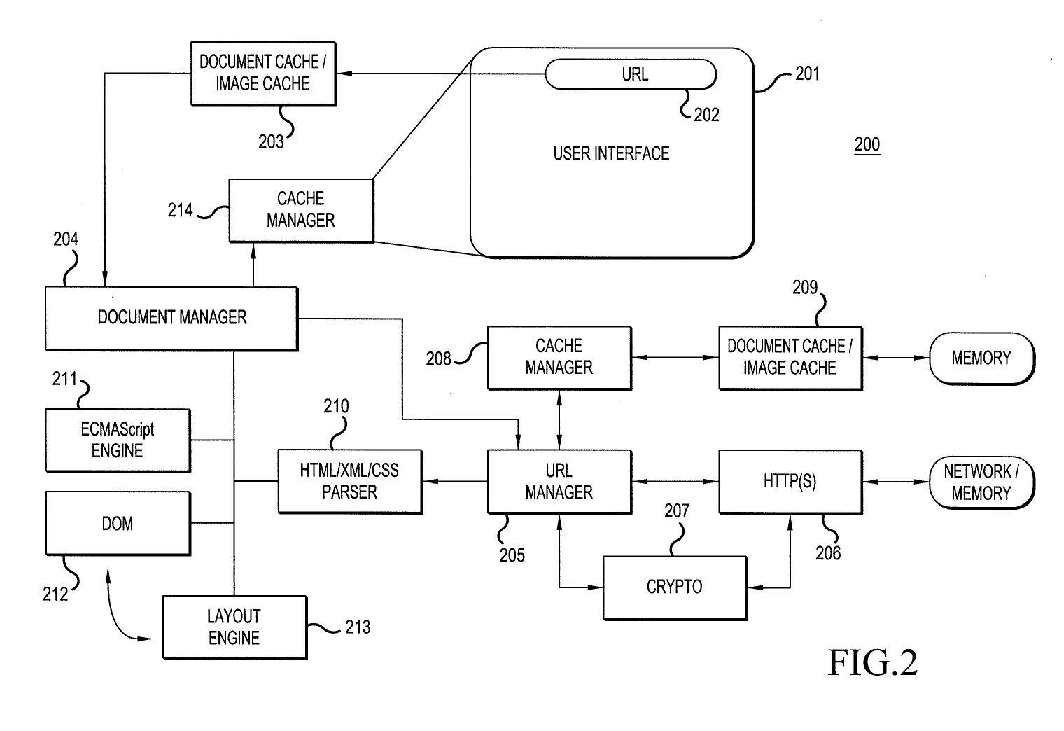

In an exemplary embodiment, various aspects of the present invention may be incorporated into, or used in connection with, the components and/or functionality making up a user agent or browser installed as an application on a device 100. FIG. 2 shows an example of a number of modules that may be present in such a user agent or browser. The modules will typically be software modules, or otherwise implemented by a programmer in software, and may be executed by the CPU 101. However, it is also possible for any of the modules of FIG. 2 to be implemented as hardware, a combination of hardware and software, or “firmware,” as will be contemplated by those skilled in the art.

The user agent or browser 200 presents the user with a user interface 201 that may be displayed on the display unit 120 shown in FIG. 1. The user interface 201 may include an address field 202 where the user may input or select the URL of a document or a service he or she wants the user agent 200 to retrieve. For example, the user may use an input device (e.g., keyboard) to type in the URL in the address field 202. The address field 202 may also be a link that is displayed and may be activated by the user using a pointing device such as a mouse. Alternatively the URL may be specified in the code of a document or script already loaded by the user agent 200.

In any case, the URL may be received by a window and input manager 203 that represents the input part of the user interface 201 associated with, or part of, the user agent 200. The URL may then be forwarded to a document manager 204, which manages the data received as part of the document identified by the URL.

The document manager 204 forwards the URL to a URL manager 205, which instructs a communication module 206 to request access to the identified resource. The communication module 206 may be capable of accessing and retrieving data from a remote device 130 such as an external server over a network using the hypertext transfer protocol (HTTP), or some other protocol such as HTTPS or FTP. The communication module 206 may also be capable of accessing data that is stored in local memory 102.

If communication outside the device 100 is required to be encrypted, e.g., as specified by the protocol used to access the URL, encryption/decryption module 207 handles communication between the URL manager 205 and the communication module 206.

The data received by the communication module 206 in response to a request is forwarded to the URL manager 205. The URL manager 205 may then store a copy of the received content in local memory 102 using a cache manager 208 which administers a document and image cache 209. If the same URL is requested at a later time, the URL manager 205 may request it from the cache manager 208, which will retrieve the cached copy from the cache 209 (unless the cached copy has been deleted) and forward the cached copy to the URL manager 205. Accordingly, it may not be necessary to retrieve the same data again from a remote device 130 when the same URL is requested a second time.

The URL manager 205 forwards the data received from the communication module 206 or cache 209 to a parser 210 capable of parsing content such as HTML, XML and CSS. The parsed content may then, depending on the type and nature of the content, be processed further by a ECMAScript engine 211 (e.g., a JavaScript engine), a module for handling a document object model (DOM) structure 212, and/or a layout engine 213.

This processing of the retrieved content is administered by the document manager 204, which may also forward additional URL requests to the URL manager 205 as a result of the processing of the received content. These additional URL's may, e.g., specify images or other additional files that should be embedded in the document specified by the original URL.

The document manager 204 may maintain a list of URLs representing the pages that have been opened. This list represents the browsing history. In a tabbed browser, the document manager may maintain a separate list for each tab that has been opened.

When the data representing the content of the specified document has been processed, it is forwarded from the document manager 204 in order to be rendered by a rendering engine 214 and displayed on the user interface 201.

The ECMAScript engine 211 described above may be implemented as a JavaScript engine, i.e., a particular type of interpreter for interpreting JavaScript source code and executing the script accordingly. JavaScript is often considered the originating dialect of ECMAScript (JScript being another such dialect). However, no limitation to any particular dialect of ECMAScript is intended. In fact, in the user agent 200, it is possible to replace the ECMAScript engine 211 of FIG. 2 with another type of script engine which interprets and executes a script language that does not fall under the ECMA-262 specification (i.e., the ECMAScript standard).

The various modules of a user agent 200 thus described are executed by the CPU 101 of device 100 as the CPU 101 receives instructions and data over the system bus(es) 106. The communications module 206 communicates with the remote device 130 using the network interface 105. The functionality of various modules in FIG. 2 may of course be integrated into fewer larger modules. Also, the functionality of a single module in FIG. 2 may be distributed or replicated over several modules.

It will further be understood that, while the user agent 200 described above may be implemented as an application program 143, some of the user agent's 200 functionality may also be implemented as part of the operating system 142 or even the BIOS 141 of the device 100. The content received in response to a URL request may be data 144, script 145, or a combination thereof as further described below.

For purpose of convenience, the terms “user agent,” “server agent,” “client agent,” and “browser” may be used hereinafter to collectively refer to both the components/functionality making up a user agent 200 (as shown in FIG. 2) and the device 100 (as shown in FIG. 1) in which such components/functionality are installed.

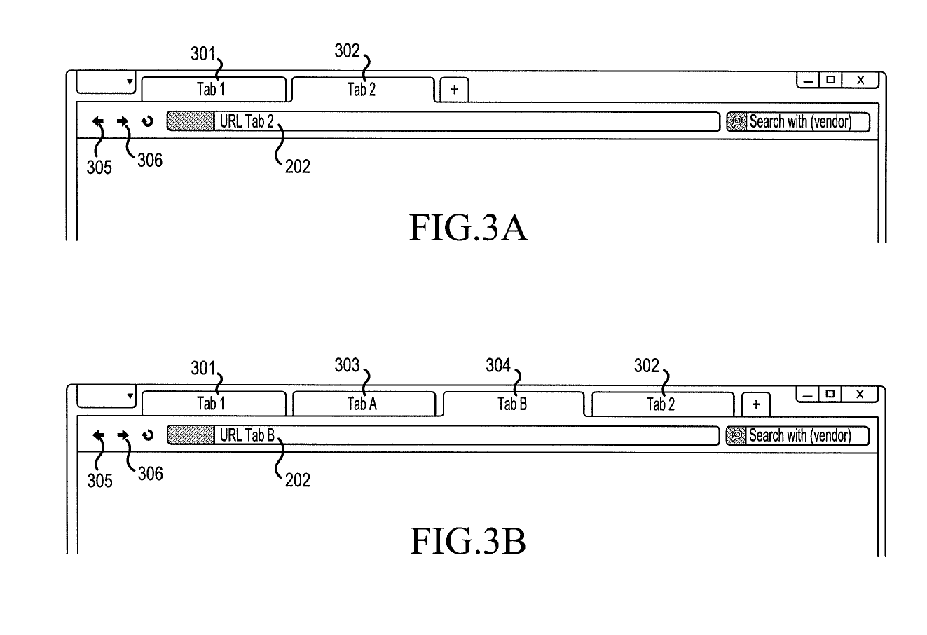

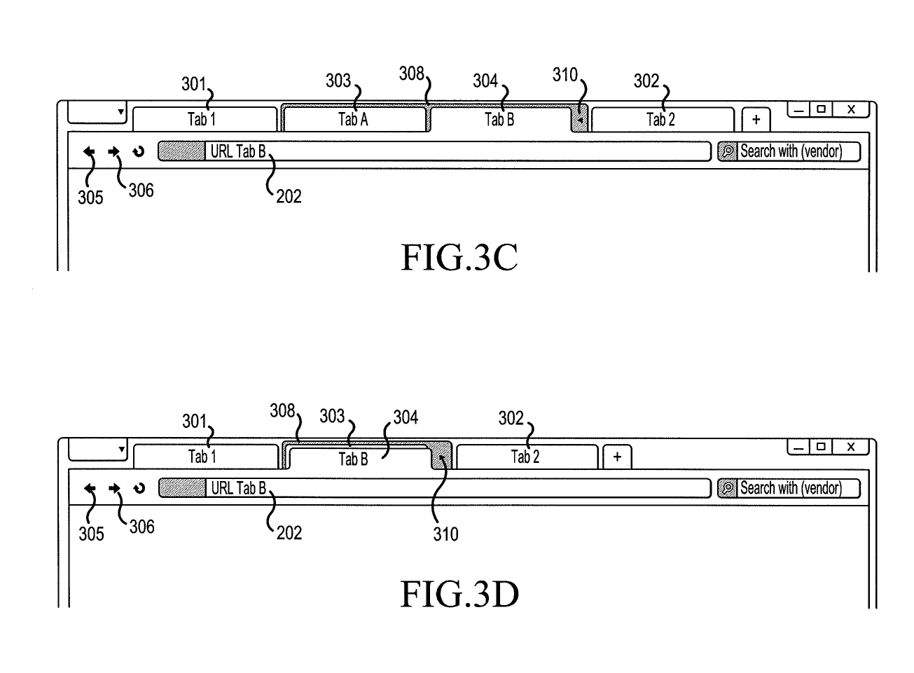

Reference is now made to FIG. 3A, which shows a part of a browser window displayed on a display unit 120 of a computer or device 100. The browser window includes an address field 202 where a user can enter an address, or a URL, in order to instruct the browser to retrieve the content stored at the location identified by the URL. The browser will then request and receive the content as described above. In a browser with multiple open tabs 301, 302, the content will be loaded in the tab that is currently active, or “has focus” and is displayed in the browser's display area.

Each tab may be associated with a list of web pages or URLs, which may be maintained by the document manager 204. This list represents the “history” of the tab. The user may select which web page in the list should be active by navigating back and forth in the list, e.g., by using the navigation buttons back 305 and forward 306, or by opening the history list and clicking on a selected page. The selected page will then be displayed.

If the user then clicks a link referring to a new web page, enters a new URL in the address field 202, or instructs the browser to load a new page by any other means, the new page will be loaded, and the page's URL will be entered at the top of the history list. If the page that was active before the new page was loaded was not itself at the top of the list (the newest page on the history list), the list may be truncated from the point of the previously active web page, and the newly loaded web page is added to the list and made active. This ensures that if the user navigates “back,” the previously loaded page will loaded again.

The user may choose to activate any tab 301, 302, through various mechanisms presented to the user, to make the corresponding page visible in the browsers display area, while deactivating the previously active tab and its associated window. The user may also choose to delete a tab, which will remove the tab from view. The associated window may be deleted altogether, moved to a dormant state, or hidden from view depending on the situation (e.g., whether other tabs exist) and design features implemented in the browser regarding, e.g., the user's ability to reopen a tab closed by error.

The document manager 204 may keep track of the tabs by maintaining a list of tabs. Each tab may be given a unique identifier, and it may be associated with a position relative to the other tabs. This may determine how the tabs are displayed.

The user may choose to rearrange the order of the tabs by dragging and dropping. This may change the visual order of the tabs as presented to the user.

FIG. 3B shows the same browser window as FIG. 3A, but now two additional tabs 303, 304 have been opened, labeled “Tab A” and “Tab B” respectively.

According to one embodiment of the invention, a tab may be associated with its own list of sub-tabs. Such a tab, which will be referred to as a “group tab,” then represents a plurality of tabs, which will be referred to as a “tab group.” The sub-tabs are normal tabs in the sense that they have their own history list and content data, just like the tabs included in the original list of tabs, but they are local to the group tab. This group tab, which may also be thought of as a “container” tab, does not itself have an associated history list of URLs. However, according to some embodiments, the group tab may be associated with a history list of which tabs it has contained.

When a group tab is made active, one of the tabs in the associated tab group will also be made active. In other words, as soon as a group tab receives focus, one of the tabs it contains also receives focus, and the contents of that tab, i.e., the contents of the selected web page in that tab's history list, will be displayed by the browser.

In order to create a group tab, a user may simply drag one tab and drop it on top of another. In response to such an event, the document manager 204 creates a group tab and enters an identification of the two tabs in a list of tabs held by this group tab. The tab may then be removed from the original list of tabs, or otherwise flagged as invisible in that list. The user may add additional tabs by dragging more tabs and dropping them on the group tab 308. FIG. 3C shows the same browser window as FIG. 3B, but now the two additional tabs 303, 304 have been grouped together in group tab 308. The group tab 308 may for example have been created by dragging tab 304 and dropping it on tab 303.

A group tab may be displayed in one of two different states, namely, collapsed or open (i.e., unfolded). FIG. 3C shows tab group 308 in its open state. In this state all tabs contained in the group are displayed normally, as if they were not part of a tab group. The group tab 308 is, in the example illustrated in 3C, shown only as a frame around the contained sub-tabs. The group tab 308 also includes a collapse button 310. If the user clicks on this collapse button the group tab is transformed to its collapsed state.

FIG. 3D shows the group tab 308 in its collapsed state. The tabs contained in the group are no longer visible, and the collapse button has been transformed to an expand button 311.

According to some embodiments, a preview of the tabs contained in a collapsed group tab can be displayed when a mouse pointer hovers above the collapsed tab. Particularly, for each tab that has been added to a group tab, a thumbnail image of the contents of that tab can be created. Further, whenever the mouse pointer hovers above the group tab in the collapsed state, the thumbnail images may be displayed, e.g., in proximity of the group tab. This would allow the user to be able to preview the contents of the respective tabs within a group tab, even though the group tab remains collapsed. As such, these thumbnails can be thought of as “thumbnail preview images.” In one embodiment, a thumbnail preview image may be created for a tab at the time such tab is added to a group tab, and then stored in memory 102. While residing in memory 102, the thumbnail preview image may further be updated as necessary, i.e., when the contents in the tab change. However, it is not necessary for the thumbnail preview images to be generated at the time the tabs are added to a group tab. For instance, the thumbnail preview images may be generated when the tabs are initially created, or on the fly when the mouse pointer hovers over the corresponding group tab. Also, there is no limitation as to where the thumbnail preview images are displayed. They could be displayed at a location defined relative to the group tab or mouse pointer, or at other locations.

Consistent with the principles of the invention, several group tabs may exist simultaneously. In some embodiments several tab groups may be open, or expanded, at the same time. Since only one tab, and consequently maximum one tab group, can have focus at any time, these embodiments allow a tab group to be open without having focus. Opening a tab group by clicking on an expand button may or may not give focus to the corresponding group tab (as a matter of design choice), and consequently focus may or may not be taken from the tab and/or group tab which already has focus when the button is clicked.

According to other embodiments expanding one group tab will result in an already open group tab to collapse, thus ensuring that only one (or no) group tab is open at any particular time. Again, focus may or may not be given to the tab group that is expanded, as a matter of design choice.

Yet other embodiments may forgo the expand and collapse buttons. For example, a tab group may expand when it is made active (given focus) and collapse when it is no longer active (or loses focus). As another example, a user may be allowed to double-click on a collapsed group tab in order to expand it, and also double-click on any tab within an expanded group tab to collapse it.

A user may choose to move a tab from a group tab to another group tab if several group tabs exist. In order to do so, the originating group tab must be open so the tab to be moved can be selected, and then the selected tab can be dragged and dropped on top of the destination group tab (which may or may not be closed). In response to such an event the document manager 204 will delete the reference to the tab from the list of tabs belonging to the originating group tab, and enter it in the list of tabs belonging to the destination group tab. A tab may also be simply removed from a tab group. The removed tab could then be reentered in the original list of tabs, or otherwise made visible again in that list. Such a tab will be displayed as a non-grouped tab in the browser window.

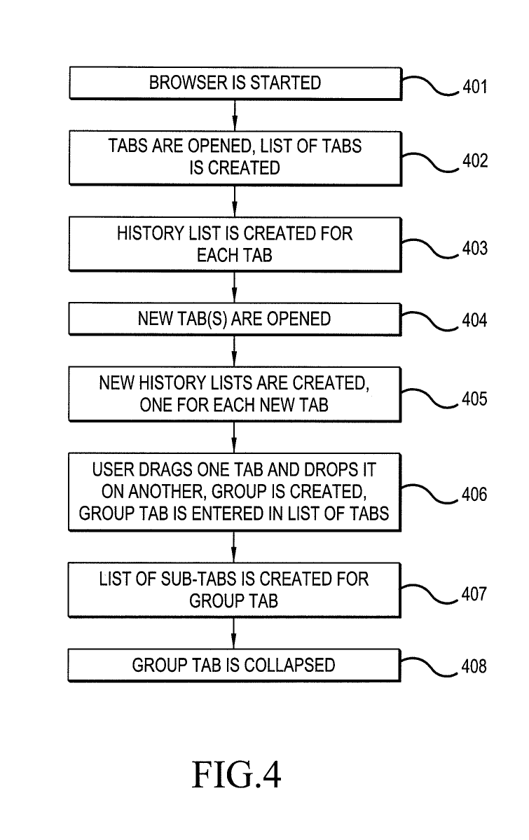

Reference is now made to FIG. 4, which illustrates a process for organizing tabs into groups as shown in FIG. 3A through FIG. 3D in a flow chart. It should be understood that the sequence of steps are determined by this particular example and will be different when the user performs other actions or performs the steps in a different order. Also, the invention is not limited to any particular sequence in which events initiated by the creation of a new tab or group tab are performed. As such, history lists may be created before, after, or simultaneously with the creation of a list of tabs or entries in the list of tabs.

In a first step 401, the browser 200 is initiated. Then in a next step 402, tabs are initially opened (e.g., the two tabs 301, 302 in FIG. 3A) and a list of tabs is created. This list may include unique identifiers for the tabs as well as an indication of the tabs present position in relation to other tabs. When the tabs are opened, a history list is created for each tab, as shown in step 403.

In step 404, additional tabs are opened. Specifically, in the example of FIG. 3B, two tabs are opened, Tab A and Tab B, and two additional entries are made in the list of tabs. Also, in step 405, additional history lists are created for the newly opened tabs (e.g., two additional history lists would be created for Tab A and Tab B, respectively).

In step 406, the user drags a tab (e.g., Tab B) and drops it on top of another tab (e.g., Tab A), thus creating a group tab (e.g., tab 308 of FIGS. 3C and 3D). The group tab is entered in the list of tabs. In step 407, a list of sub-tabs is created for the group tab, and the grouped-together tabs (e.g., Tab A and Tab B) are entered in this list. These grouped-together tabs may be deleted from the original (or top level) list of tabs, or alternatively they may be flagged as hidden, moved to a tab group, or otherwise temporarily disabled from the top level list of tabs.

In step 408, the group tab is collapsed.

It will be understood by those with skill in the art that while in the examples discussed above describes various lists including history lists and tab lists, these lists can be implemented in a number of ways, e.g., as text files, internal text string variables, or arrays of variables.

It should be noted that the dragging and dropping of tabs, or other methods of moving tabs, may involve mouse and keyboard events as well as mouse movements. Such events are generally sent to the relevant application program by the operating system. The application program would then process these events and movements by means of a subroutine called an event handler, in a manner that is well known to persons of ordinary skill in the art. The event handler sends these events and movements to the subroutines that implement the processes described above, thus driving the algorithms described with reference to FIG. 4.

With particular embodiments being described above for purposes of example, the present invention covers any and all obvious variations as would be readily contemplated by those of ordinary skill in the art.

What is claimed is:

1. A method in a browser for providing grouping of tabs when multiple web pages are open in multiple tabs, the method comprising:
utilizing a computer processor to execute a process comprising:
detecting a user initiated event indicating the creation of a group of tabs;
associating at least two tabs with the created group; and
displaying a group tab representing the group of tabs.

2. The method of claim 1, wherein said tab representing the group of tabs can be displayed in one of the following two states: a collapsed state, and an open state, and
wherein the contained tabs are shown in the open state, but not in the collapsed state.

3. The method of claim 2, wherein a collapsed tab is displayed with a button that toggles the tab to an open state and an open tab is displayed with a button that toggles the tab to a collapsed state.

4. The method of claim 2, wherein the process further comprises:
when said tab representing the group of tabs is displayed in a collapsed state, displaying a preview of the respective contents of the group of tabs.

5. The method of claim 1, wherein the user initiating event comprises dragging and dropping one tab on top of another with a mouse type input device.

6. The method of claim 1, wherein the process further comprises:
maintaining a list of all open tabs at a first level;
upon creating said group of tabs, creating a first list of tabs at a second level; and
entering an identification of a group tab associated with said group of tabs in said list of tabs at the first level, and entering an identification of said at least two tabs in said first list of tabs at a second level.

7. The method of claim 6, wherein the process further comprises:
upon detecting a user initiated event indicating the creation of a second group of tabs, creating a second list of tabs at said second level; and
entering an identification of a group tab associated with said second group of tabs in said list of tabs at the first level, and entering an identification of at least two tabs associated with said second group of tabs in said second list of tabs at said second level.

8. A computer system in which a browser is implemented for providing grouping of tabs when multiple web pages are open in multiple tabs, the computer system comprising:
a computer processor programmed to execute a process comprising:
detecting a user initiated event indicating the creation of a group of tabs;
associating at least two tabs with the created group; and
displaying a group tab representing the group of tabs.

9. The computer system of claim 8, wherein said tab representing the group of tabs can be displayed in one of the following two states: a collapsed state, and an open state, and
wherein the contained tabs are shown in the open state, but not in the collapsed state.

10. The computer system of claim 9, wherein a collapsed tab is displayed with a button that toggles the tab to an open state and an open tab is displayed with a button that toggles the tab to a collapsed state.

11. The computer system of claim 9, wherein the process further comprises:
when said tab representing the group of tabs is displayed in a collapsed state, displaying a preview of the respective contents of the group of tabs.

12. The computer system of claim 8, wherein the user initiating event comprises dragging and dropping one tab on top of another with a mouse type input device.

13. The computer system of claim 8, wherein the process further comprises:
maintaining a list of all open tabs at a first level;
upon creating said group of tabs, creating a first list of tabs at a second level; and
entering an identification of a group tab associated with said group of tabs in said list of tabs at the first level, and entering an identification of said at least two tabs in said first list of tabs at a second level.

14. The computer system of claim 13, wherein the process further comprises:
upon detecting a user initiated event indicating the creation of a second group of tabs, creating a second list of tabs at said second level; and
entering an identification of a group tab associated with said second group of tabs in said list of tabs at the first level, and entering an identification of at least two tabs associated with said second group of tabs in said second list of tabs at said second level.

15. A nontransitory computer readable medium on which is stored program code for allowing a browser to provide grouping of tabs when multiple web pages are open in multiple tabs, wherein the program code includes instructions that, when executed by a computer processor, performs a process comprising:
detecting a user initiated event indicating the creation of a group of tabs;
associating at least two tabs with the created group; and
displaying a group tab representing the group of tabs.

16. The computer readable medium of claim 15, wherein said tab representing the group of tabs can be displayed in one of the following two states: a collapsed state, and an open state, and
wherein the contained tabs are shown in the open state, but not in the collapsed state.

17. The computer readable medium of claim 16, wherein a collapsed tab is displayed with a button that toggles the tab to an open state and an open tab is displayed with a button that toggles the tab to a collapsed state.

18. The computer readable medium of claim 16, wherein the user initiating event comprises dragging and dropping one tab on top of another with a mouse type input device.

19. The computer readable medium of claim 16, wherein the process further comprises:
maintaining a list of all open tabs at a first level;
upon creating said group of tabs, creating a first list of tabs at a second level; and
entering an identification of a group tab associated with said group of tabs in said list of tabs at the first level, and entering an identification of said at least two tabs in said first list of tabs at a second level.

20. The computer readable medium of claim 19, wherein the process further comprises:
upon detecting a user initiated event indicating the creation of a second group of tabs, creating a second list of tabs at said second level; and
entering an identification of a group tab associated with said second group of tabs in said list of tabs at the first level, and entering an identification of at least two tabs associated with said second group of tabs in said second list of tabs at said second level.
